(19) United States
(12) Patent Application Publication
(10) Pub. No.: US 2019/0297504 A1
(43) Pub. Date: Sep. 26, 2019

(54) TERMINAL DEVICE, REGISTRATION-PROCESSING METHOD, AND NON-TRANSITORY COMPUTER-READABLE RECORDING MEDIUM STORING PROGRAM

(71) Applicant: FUJITSU CLIENT COMPUTING LIMITED, Kawasaki-shi (JP)

(72) Inventor: Satoshi IIDA, Kawasaki-shi (JP)

(21) Appl. No.: 16/440,518

(22) Filed: Jun. 13, 2019

Related U.S. Application Data
(63) Continuation of application No. PCT/JP2018/005749, filed on Feb. 19, 2018.

(30) Foreign Application Priority Data
Mar. 8, 2017 (JP) 2017-044155

(51) Int. Cl. H04W 12/12; H04M 1/725; H04L 12/24

(52) U.S. Cl. CPC H04W 12/1206; H04L 41/0813; H04M 1/72522

(57) ABSTRACT

A terminal device configured to receive a remote data erasure service from a management device, includes a storage unit configured to store SIM information and unlock password information relating to a communication with the manager device; a lock control unit configured to lock the terminal device when the SIM information recognized by the terminal device is determined to be different from the stored SIM information by referring to the storage unit; a reception unit configured to receive an input of password information after the terminal device is locked; and a registration unit configured to register the recognized SIM information in the storage unit when the received password information is determined to be the same as the stored unlock password information.

This application is a continuation application of PCT International Application No. PCT/JP2018/005749, filed on Feb. 19, 2018, which claims priority to Japanese Patent Application No. 2017-044155, filed on Mar. 8, 2017. The entire contents of both of the above PCT International Application and the above Japanese Patent Application are incorporated herein by reference.

### BACKGROUND

### Technical Field

The present invention relates to a terminal device, a registration-processing method, and a non-transitory computer-readable recording medium storing program.

### Description of Related Art

As a countermeasure against information leakage due to theft or loss of a terminal device such as a personal computer (PC), for example, a service of CLEARSURE (registered trademark) capable of remotely erasing data stored in a terminal device after the occurrence of an accident has been proposed (for example, see Remote Data Erasure CLEARSURE 3G/LTE Introduction http://www.fmworld.net/biz/fmv/lifebook/clearsure/). Also, technology for locking an operation key of a portable phone by remote control to prevent unauthorized use of the portable phone when the portable phone has been lost has been proposed (see, for example, Japanese Unexamined Patent Application, First Publication No. 2008-278108, Japanese Unexamined Patent Application, First Publication No. 2009-134442, Japanese Unexamined Patent Application, First Publication No. 2009-151717, and PCT International Publication No. WO 2012/105031).

In the remote data erasure service as described above, a person illegally obtaining a terminal device is prevented from performing an operation in which a command for erasing data of an HDD of the terminal device from a server device according to a request of a user of an authorized terminal device is not accepted by replacing a SIM attached to the terminal device. Thus, when the SIM registered in advance in the terminal device is different from the SIM attached to the terminal device, a mechanism is provided to prevent the terminal device from being started.

However, according to the above-described mechanism, when an authorized user needs to replace the SIM attached to the terminal device, the terminal device will not start if an unregistered SIM is inserted into the terminal device. Thus, time and effort are required because it is necessary to insert the unregistered SIM into the terminal device after a process of invalidating the above mechanism is temporarily performed and register the new SIM inserted into the terminal device in a server device.

Therefore, in an aspect, an objective of the present invention is to reduce time and effort when a SIM of a terminal device for receiving the provision of a remote data erasure service is replaced.

### SUMMARY

In an embodiment, a terminal device configured to receive a remote data erasure service from a management device includes a storage unit configured to store SIM information and unlock password information relating to a communication with the manager device; a lock control unit configured to lock the terminal device when the SIM information recognized by the terminal device is determined to be different from the stored SIM information by referring to the storage unit; a reception unit configured to receive an input of password information after the terminal device is locked; and a registration unit configured to register the recognized SIM information in the storage unit when the received password information is determined to be the same as the stored unlock password information.

### BRIEF DESCRIPTION OF THE DRAWINGS

FIG. 1 is a flowchart showing an example of a conventional operation when a SIM of a terminal device is replaced.

FIG. 2 is a diagram showing an example of a hardware configuration of a terminal device according to an embodiment.

FIG. 3 is a view showing an example of data stored in storage areas of the terminal device and a management server according to the embodiment.

FIG. 4 is a diagram showing an example of a functional configuration of the terminal device according to the embodiment.

FIG. 5 is a flowchart showing an example of a conventional operation when an unregistered SIM is inserted into the terminal device.

FIG. 6 is a flowchart showing an example of a registration process when a SIM of a terminal device is replaced according to a first embodiment.

FIG. 7 is a flowchart showing an example of a registration process when a SIM of a terminal device is replaced according to a second embodiment.

### DESCRIPTION OF EMBODIMENTS

Hereinafter, embodiments of the present invention will be described with reference to the accompanying drawings. Also, in the present description and the drawings, components having substantially the same functional configuration will be denoted by the same reference signs and redundant description thereof will be omitted.

### Remote Data Erasure Service

As a countermeasure against information leakage, for example, there is a CLEARSURE (registered trademark) service (hereinafter referred to as a “remote data erasure service”) capable of remotely erasing data stored in a target terminal device after the occurrence of an accident. The remote data erasure service includes a service for remotely erasing data stored in an HDD provided in the terminal device and a service for remotely locking the terminal device.

In order to use the remote data erasure service, the terminal device is first required to perform initial registration (hereinafter also referred to as “activation”). When this activation is performed, information of a SIM card attached to the terminal device (hereinafter referred to as “SIM information”) is registered in association with terminal information specific to the terminal device.

A terminal device lock instruction or an HDD data erasure instruction provided by the remote data erasure service is transmitted to a SIM phone number registered in a management server as a command of a short mail service (hereinafter referred to as an “SMS”) provided by a carrier (a communication carrier). Thus, when the SIM card of the SIM phone number different from the initially registered SIM phone number is inserted into the terminal device, the terminal device cannot receive the remote data erasure service.

Also, in the remote data erasure service, there is a mechanism for locking the terminal device to prevent the terminal device from being started when a SIM card other than the registered SIM card is inserted into the terminal device or the SIM card is removed from the terminal device. This is to prevent the lost terminal device from being illegally used by avoiding a terminal device lock instruction or an instruction for erasing data stored inside the terminal device. Thus, when a user of the terminal device desires to use a SIM card different from the SIM card of the SIM information registered in advance, it is not possible to use the terminal device when activation is not performed again using new SIM information after the registration cancellation of registered SIM information (hereinafter, also referred to as “deactivation”) is temporarily performed.

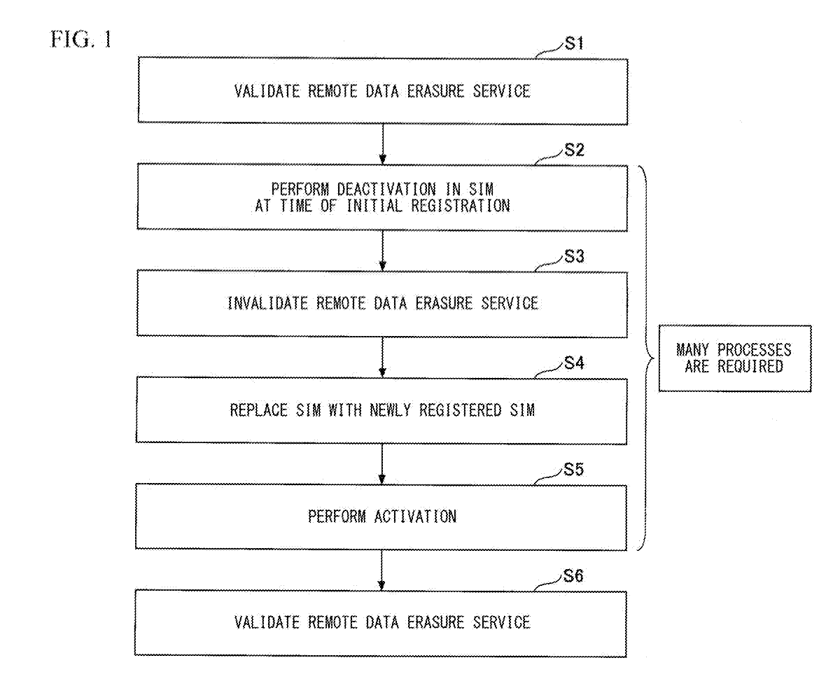

For example, an example of a conventional operation when a SIM card attached to a terminal device configured to receive the provision of a remote data erasure service is replaced is shown in FIG. 1. As a premise, a service contract flag is turned on and the remote data erasure service for the terminal device is in a valid state (step S1). In this state, deactivation is first performed on SIM information at the time of initial registration when the SIM card of the terminal device is replaced (step S2). Next, the service contract flag is turned off and the remote data erasure service for the terminal device is invalidated (step S3).

Next, when the user inserts the SIM card to be newly registered into the terminal device (step S4), the activation is executed (step S5). Thereafter, the service contract flag is turned on and the remote data erasure service for the terminal device is validated (step S6).

The above-described activation (SIM registration) and deactivation (SIM registration cancellation) will be described below.

First, the activation (initial registration) will be described. When the user inserts a SIM card into the terminal device that performs the initial registration to receive the provision of the remote data erasure service and turns on a power supply of the terminal device, the terminal device is started. When a process of starting the terminal device is completed, an OS is booted up, a program of an initial registration application (a registration application) on the OS is started, and the registration application operates under control of a central processing unit (CPU). The started registration application acquires SIM information (a SIM phone number, a personal identification number (PIN) number, and the like) and terminal information (a device type name, a device serial number, an HDD serial number, and the like) stored in a communication module (a WAN module) of the terminal device.

When the user inputs contract information (a user ID, a password, and the like) and an activation execution button is pressed, the registration application receives the contract information and executes the activation. The registration application is connected to the management server and the received contract information is compared with contract information registered in the management server. When a comparison result indicates that it is determined that the contract information is the same, the registration application registers the acquired SIM information and terminal information in the management server in association with the contract information. At this time, data transmission is performed by a network via a wired local area network (LAN) instead of the SMS.

When a normal registration completion notification is received from the management server, the registration application notifies an embedded controller (EC), which operates independently of the CPU, of the SIM phone number and the password.

The EC records the SIM phone number and the password inside the EC. The EC transmits an AT command to the communication module, sets a service contract flag stored inside the communication module to an on (valid) state, and validates the remote data erasure service. Also, the EC sets the internally stored service contract flag to the on (valid) state.

After it is confirmed that the EC service contract flag is set to the on state, the registration application notifies the management server that activation (registration) of the terminal device has been completed. Thereby, a provision state of the remote data erasure service for the terminal device in the management server becomes “valid”. The terminal device 10 is restarted to complete the activation.

Next, the registration cancellation (deactivation) will be described. When the user inserts a registered SIM card into a terminal device for which registration (activation) of the remote data erasure service has been completed and the OS is started, the terminal device is connected to the management server via the wired LAN. The management server executes the deactivation as follows.

First, under control of the CPU, the registration application on the OS executes a “latest situation report” operation. Next, the registration application receives a deactivation notification from the management server and notifies the EC of the deactivation.

The EC sends an AT command to the communication module, sets the service contract flag stored inside the communication module to an off state, and invalidates a function of the remote data erasure service.

The EC erases the internally recorded SIM phone number and changes the service contract flag to the off state. The EC notifies the registration application of the completion of the deactivation. The registration application receives the notification of the EC, sets the service contract flag to the off state, and changes the provision state of the remote data erasure service of the registration information on the management server side to an “invalid” state. The terminal device is restarted to complete the deactivation.

When the activation is performed with a SIM card other than the registered SIM card after the deactivation is completed, it is necessary to erase the terminal information and the SIM information registered on the management server side before the activation is performed. When there is no change in registration information, it is unnecessary to erase the information thereof.

Although a connection via the network is required because it is necessary to communicate with the management server at the time of the deactivation and activation described above, communication using a wireless wide area network (WAN) is not structurally possible during processes thereof. Thus, it is necessary to connect the terminal device and the management server via a wired LAN serving as a network other than the wireless WAN.

In this manner, if activation is performed again when the SIM card of the terminal device is replaced, significant time and effort required in a conventional operation such as a restoration time required when a procedure is wrong become problematic in addition to the need for the wired LAN and the need for administrator authority.

In the future, the number of cases in which SIM cards of terminal devices are replaced is expected to increase when a SIM-free system is provided and restrictions on available carriers are eliminated. In consideration thereof, it is desirable to facilitate the replacement of a SIM card after activation in a remote data erasure service and reduce time and effort when a SIM card of a terminal device for receiving the provision of a remote data erasure service is replaced.

Therefore, in the terminal device according to the present embodiment, a method is provided in which the remote data erasure service is received as it is even when activation is not performed again when a SIM card different from the SIM card at the time of initial registration is used. Thereby, it is possible to reduce time and effort when the SIM card of the terminal device for receiving a remote data erasure service is replaced.

### System Configuration and Hardware Configuration of Terminal Device

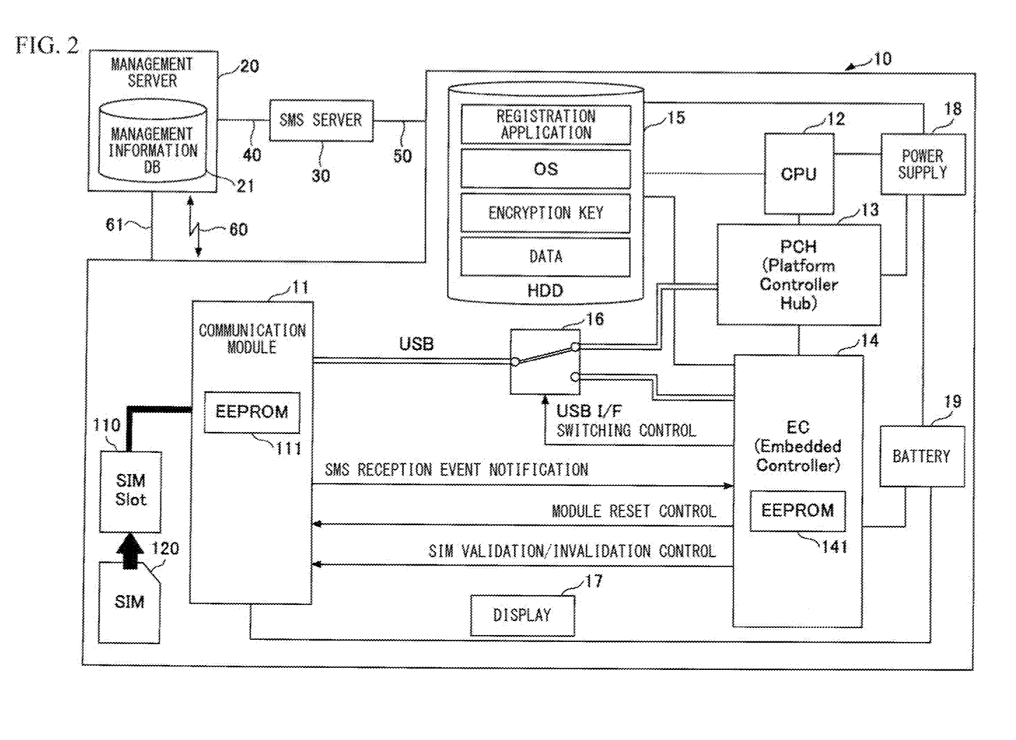

A system configuration and a hardware configuration of the terminal device 10 according to the present embodiment will be described with reference to FIG. 2. FIG. 2 shows an example of a system configuration and a hardware configuration of the terminal device 10 according to the embodiment. The system according to the present embodiment includes a terminal device 10 and a management server 20. The terminal device 10 receives the provision of the remote data erasure service from the management server 20.

The management server 20 is an example of a management device that provides the remote data erasure service. The terminal device 10 is registered in advance in the management server 20 to use the remote data erasure service (activation). When the activation is performed, terminal information specific to a terminal device and information (SIM information) of a SIM card attached to the terminal device are associated and registered in the management server 20. The terminal information includes a device type name, a device serial number, and an HDD serial number. The SIM information includes a phone number and a PIN code. The device serial number is a serial number assigned to the terminal device and the HDD serial number is a serial number assigned to the HDD in the terminal device. The PIN code is a password number for the SIM card.

The terminal device 10 and the management server 20 are connected via a wireless wide area network (WAN) 60. Because the terminal device 10 is required to communicate with the management server 20 at the time of deactivation and activation, it is necessary to establish a connection to the network. At this time, in the network connection via the wireless LAN, it is preferable to establish a network connection via the wired LAN 61 because the connection may become unstable and problems may occur. Also, communication standards such as Long-Term Evolution (LTE) and 3G can be used for the wireless WAN 60.

A method of remote control when the terminal device 10 is stolen or lost includes a method of interposing the SMS server 30 between the terminal device 10 and the management server 20 and transmitting a command for erasing data stored in an HDD 15 of the terminal device 10 according to the SMS from the SMS server 30. The SMS server 30 is connected to the management server 20 and the terminal device 10 via a network 40 or 50 such as the Internet.

The SMS server 30 stores SIM information of the terminal device 10 in advance. The SMS server 30 receives an instruction for erasing data stored in the HDD 15 of the terminal device 10 from the management server 20. In response to the received instruction, the SMS server 30 transmits a command in the SMS with respect to the SIM information (a SIM phone number) of the terminal device 10 and instructs the terminal device 10 to erase the data stored in the HDD 15. The terminal device 10 executes the erasure of the data subjected to the instruction and returns an execution result, location information of the terminal device 10, and the like. The execution result, the location information, and the like returned from the terminal device 10 are transmitted to the management server 20 via the SMS server 30. Although a method of executing data erasure has been briefly described above, it is also possible to execute the locking of the terminal device 10 using the same means at the time of theft or loss of the terminal device 10.

Next, an example of the hardware configuration of the terminal device 10 will be described. The terminal device 10 can be an electronic device such as a PC, a smartphone, or a tablet terminal. The terminal device 10 includes a communication module 11, a CPU 12, a platform controller hub (PCH) 13, an EC 14, an HDD 15, a USB bus switch 16, a display 17, a power supply 18, and a battery 19.

The communication module 11 has a function of performing data communication with the management server 20 via the wireless WAN 60. When a SIM card 120 is inserted into a SIM slot 110, the communication module 11 stores SIM information of the inserted SIM card 120 in an electronically erasable and programmable read-only memory (EEPROM) 111 in correspondence with the terminal information of the terminal device 10.

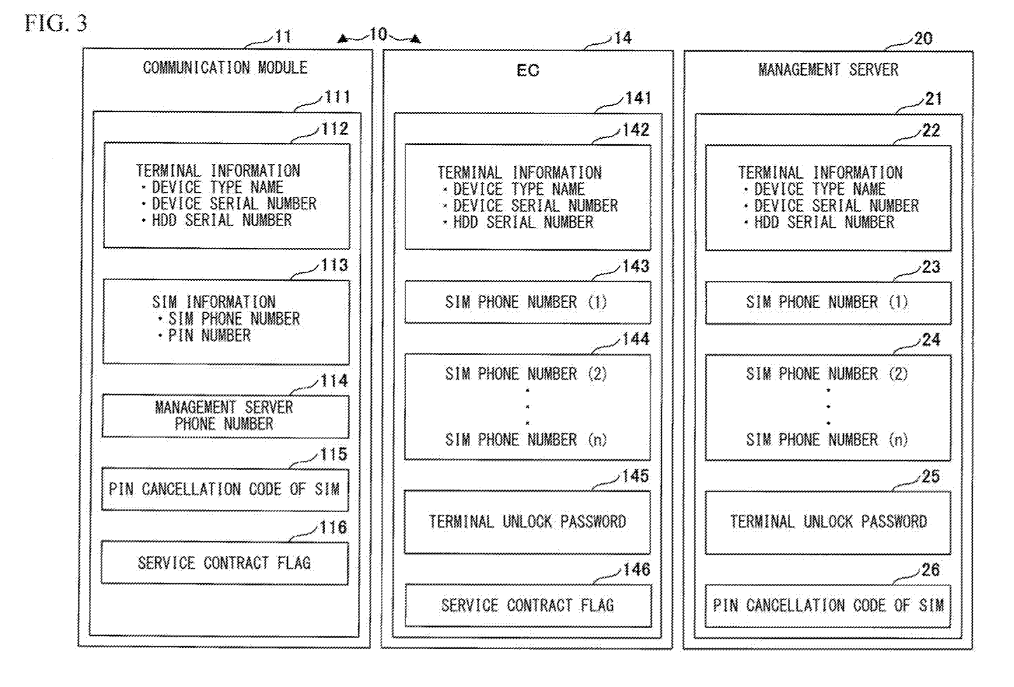

FIG. 3 shows an example of data stored in storage areas of the terminal device 10 and the management server 20 according to the present embodiment. Terminal information 112 and SIM information 113 are stored in the EEPROM 111 embedded in the communication module 11. In FIG. 3, as an example of the terminal information 112, a device type name, a device serial number, and an HDD serial number are stored. Also, as an example of the SIM information 113, a SIM phone number and a PIN number are stored. In addition, in the EEPROM 111, a management server phone number 114, a PIN cancellation code 115 of the SIM, and a service contract flag 116 are stored.

Returning to FIG. 2, while the power supply 18 is being turned on, power is supplied to each part of the terminal device 10. The terminal device 10 is provided with the battery 19 connected to the power supply 18. The power from the battery 19 is supplied to the communication module 11 and the EC 14 even when the power supply 18 of the terminal device 10 is turned off. Consequently, also in a state in which the power supply of the terminal device 10 is turned off, the communication module 11 can stand by to receive a data erasure instruction from the management server 20 at any time.

When the communication module 11 receives the data erasure instruction according to the SMS from the SMS server 30, the communication module 11 notifies the EC 14 of a reception event from the SMS. Also, the communication module 11 also provides a notification of an execution result with respect to the data erasure instruction in the SMS. Here, data stored in the HDD 15 is encrypted. Consequently, the EC 14 prevents the data saved in the HDD 15 from being restored by erasing an encryption key for decrypting the encrypted data without actually erasing the data stored in the HDD 15 in response to the data erasure instruction from the management server 20.

The CPU 12 is an arithmetic device that reads a registration application operating on the OS stored in the HDD 15 and executes activation or deactivation by starting the registration application.

The EC 14 is a controller operable independently of the CPU 12. The EC 14 controls the resetting of the communication module 11. Also, the EC 14 controls the replacement of the SIM card in the terminal device 10 in the registration process according to the present embodiment and controls validity and invalidity of the SIM card.

The EC 14 stores SIM information in the EEPROM 141 at the time of activation. As shown in FIG. 3, terminal information 142, which is terminal information of the terminal device 10, and SIM information (SIM phone number (1) 143) are associated and stored in the EEPROM 141 at the time of activation.

Also, in a registration process when the SIM card of the terminal device 10 according to the present embodiment is replaced, new SIM information (SIM phone number (2) 144) after replacement, a terminal unlock password 145, and a service contract flag 146 are stored. In the EEPROM 141, n is incremented by one every time the SIM card of the terminal device 10 according to the present embodiment is replaced and new SIM information (SIM phone number (n: n≥12, that is, n is equal to or larger than 2) 144) can be registered.

Returning to FIG. 2, the PCH 13 is connected to the CPU 12 and the EC 14. Also, the PCH 13 can be connected to the communication module 11 via the USB bus switch 16. When a prescribed instruction is received from the CPU 12 under the control of the CPU 12, the PCH 13 transfers the corresponding instruction to the EC 14 or the communication module 11.

A universal serial bus (USB) bus switch 16 switches a USB connection to the communication module 11 to either the PCH 13 or the EC 14 under the control of the EC 14 using a USB interface (I/F). The display 17 displays an input screen of a password or the like.

Also, an example of information stored in a management information DB 21 retained by the management server 20 shown in FIG. 2 is shown in FIG. 3. The management information DB 21 stores terminal information 22 and SIM phone number (1) 23 in association. Also, in the management information DB 21, in the registration process when the SIM card of the terminal device 10 according to the present embodiment is replaced, new SIM information after replacement (SIM phone number (2) 24), a terminal unlock password 25, and a PIN cancellation code 26 of the SIM are stored. n is incremented by one every time the SIM card of the terminal device 10 according to the present embodiment is replaced and new SIM information (SIM phone number (n: n≥2) 24) can be registered.

As described above, the terminal device 10 and the management server 20 according to the present embodiment enable registration of a plurality of SIM phone numbers. Additional registration of SIM phone numbers (2) to (n) (n≥2, that is, n is equal to or larger than 2) is executed when the SIM card 120 inserted into the SIM slot 110 is replaced after activation and a SIM phone number different from the SIM phone number registered at the time of activation is recognized by the terminal device 10. At this time, the terminal device 10 transmits the recognized SIM phone number and the terminal information to the SMS server 30 and the SMS server 30 transmits the received SIM phone number and terminal information to the management server 20 in the SMS.

When the management server 20 confirms that the transmitted terminal information indicates the terminal device 10 registered in advance, an unlock instruction command to which a terminal unlock password registered in advance in correspondence with the terminal device 10 is attached is transmitted to the SMS server 30 in the SMS.

The terminal device 10 receives the unlock instruction command to which the terminal unlock password is attached via the SMS server 30. When the user of the terminal device 10 inputs a password to a password input screen, the terminal device 10 compares the input password with the terminal unlock password to determine whether the input password and the terminal unlock password are the same. When it is determined that the input password and the terminal unlock password are the same, the terminal device 10 is unlocked and the terminal device 10 can be used. When the terminal device 10 is unlocked, the terminal device 10 updates the SIM information. The terminal device 10 transmits an unlock notification command to which the updated SIM information is attached to the management server 20 via the SMS server 30 in the SMS and the management server 20 updates the SIM information of the management information DB 21.

### Functional Configuration of Terminal Device

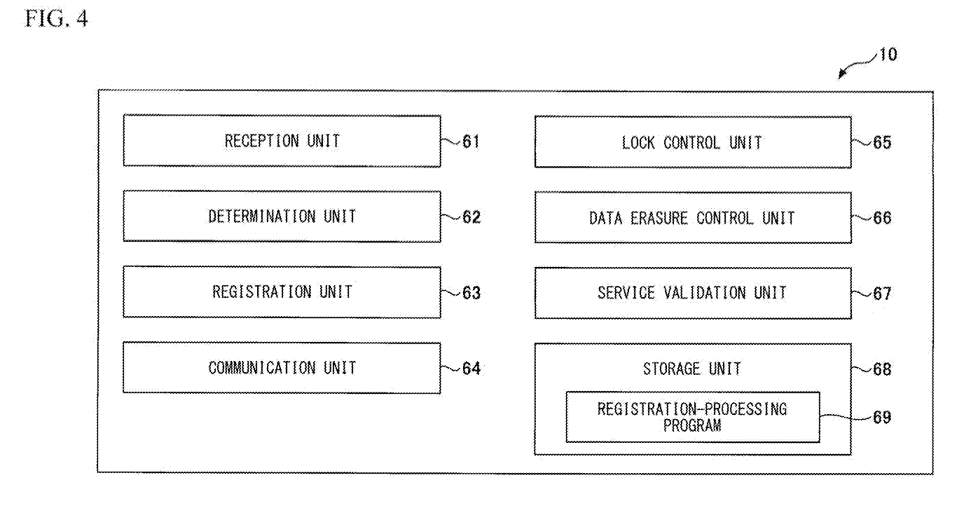

Next, a functional configuration of the terminal device 10 according to the present embodiment will be described with reference to FIG. 4. FIG. 4 shows an example of the functional configuration of the terminal device 10 according to the embodiment. The terminal device 10 includes a reception unit 61, a determination unit 62, a registration unit 63, a communication unit 64, a lock control unit 65, a data erasure control unit 66, a service validation unit 67, and a storage unit 68.

When it is determined that SIM information recognized in accordance with the start of the terminal device 10 is different from registered SIM information, the reception unit 61 receives an input of a terminal unlock password for unlocking. Also, when a plurality of pieces of SIM information are registered, the reception unit 61 receives an input of password information when it is determined that the SIM information recognized in accordance with the start of the terminal device 10 is different from any of the plurality of piece of registered SIM information. The function of the reception unit 61 can be implemented by, for example, the EC 14.

The determination unit 62 determines whether or not the SIM information recognized by the terminal device 10 is the same as the registered SIM information. The determination unit 62 determines whether or not the received terminal unlock password is the same as the registered terminal unlock password. The function of the determination unit 62 can be implemented by, for example, the EC 14.

The registration unit 63 registers SIM information in association with the terminal information of the terminal device 10. When it is determined that the received terminal unlock password is the same as the registered terminal unlock password, the registration unit 63 registers the recognized SIM information. The function of the registration unit 63 can be implemented, for example, by a process executed in the CPU 12 by a program of a registration application installed in the HDD 15 or by the EC 14.

The communication unit 64 communicates with the management server 20 in wireless and wired manners. For example, the function of the communication unit 64 can be implemented by the communication module 11.

The lock control unit 65 locks the terminal device 10 when it is determined that the SIM information recognized in accordance with the start of the terminal device 10 is different from the registered SIM information.

The data erasure control unit 66 rewrites an encryption key of the HDD 15 with respect to the data erasure instruction from the management server 20 and therefore the data saved in the HDD 15 cannot be restored.

The service validation unit 67 controls a service contract flag indicating whether the remote data erasure service is in a valid state or an invalid state with respect to the terminal device 10. The service validation unit 67 turns on the service contract flag when the remote data erasure service is valid with respect to the terminal device 10 and turns off the service contract flag when the remote data erasure service is invalid with respect to the terminal device 10. For example, functions of the lock control unit 65, the data erasure control unit 66, and the service validation unit 67 are implemented by the EC 14.

The storage unit 68 stores a registration-processing program 69. Also, as shown in FIG. 3, the storage unit 68 stores terminal information, SIM information, a terminal unlock password, a service contract flag, and the like. The function of the storage unit 68 can be implemented by, for example, the EEPROM 111, the EEPROM 141, and the like.

Also, FIG. 4 is a block diagram focusing on functions and a processor for executing software of parts indicated by these functional blocks is hardware.

Conventional Operation when Unregistered SIM is Inserted at Time of Service Validation

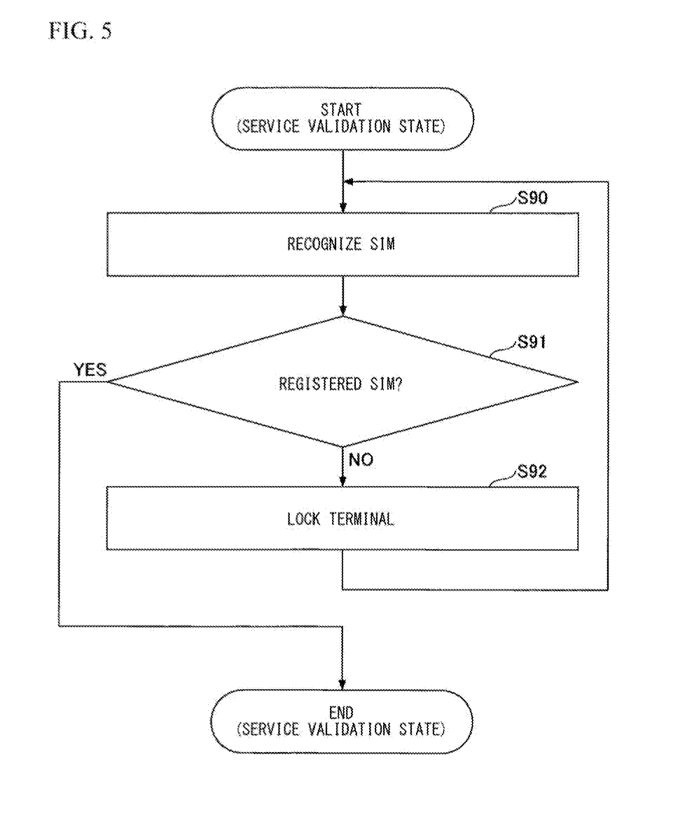

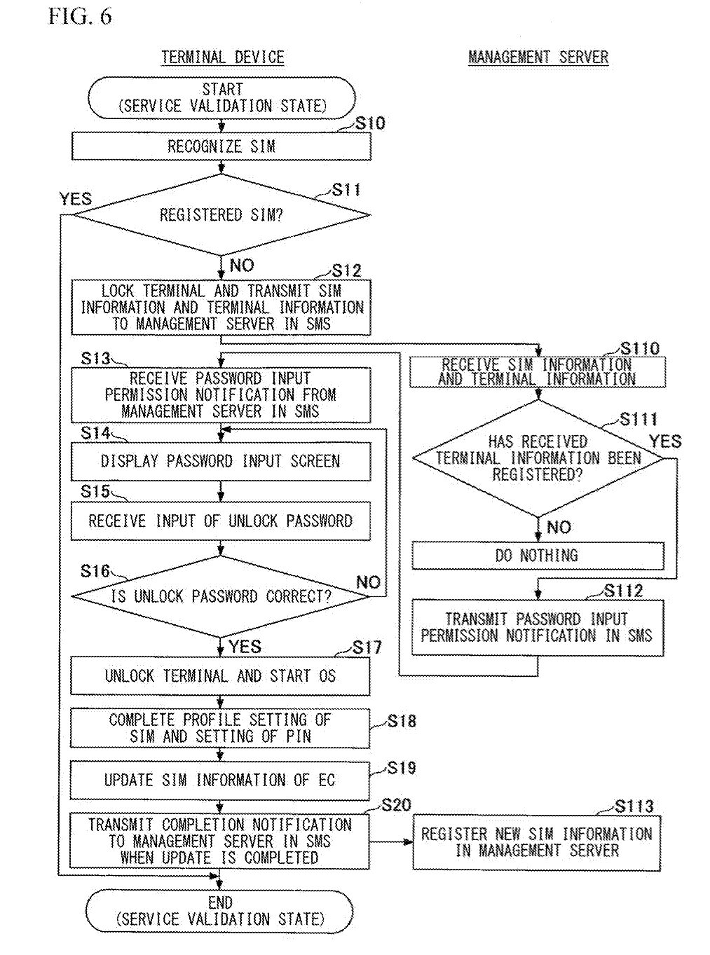

For comparison, a conventional operation of a case in which the unregistered SIM card 120 is inserted when the remote data erasure service is valid will be described with reference to FIG. 5. Thereafter, the operation of the terminal device 10 according to the first embodiment in a case in which the unregistered SIM card 120 is inserted when the remote data erasure service is valid will be described with reference to FIG. 6.

In the operation of the conventional terminal device, when the process of FIG. 5 is started in a state in which the remote data erasure service is valid, the terminal device recognizes the SIM card inserted into a SIM slot (step S90). Next, the terminal device determines whether or not SIM information indicated by the recognized SIM card is the same as registered SIM information (step S91). When it is determined that the recognized SIM information is the same as the registered SIM information, the present process ends. At this time, the remote data erasure service is maintained in a valid state.

On the other hand, when it is determined that the recognized SIM information is not the same as the registered SIM information in step S91, the terminal device is locked (step S92). Then, the process returns to step S90 and the terminal device iterates the processing of steps S90 to S92 until a SIM which is the same as the registered SIM is recognized in step S91.

Operation of First Embodiment when Unregistered SIM is Inserted at Time of Service Validation

On the other hand, in the terminal device 10 according to the first embodiment, when an unregistered SIM is inserted into the terminal device 10, the following registration process is mainly performed by the EC 14. As a premise, at the start of execution of this process, the service contract flag 146 is set to an on state and the remote data erasure service is in a valid state.

First, the reception unit 61 recognizes the SIM card 120 inserted into the SIM slot 110 (step S10). The recognition process of step S10 is performed immediately after the power supply is turned on in the communication module 11, i.e., immediately after the power supply 18 is turned on from a shutdown state (G3) in the terminal device 10. In other words, in the state in which the OS is started (S0), even if the SIM card 120 is replaced, the SIM cannot be recognized. However, if there is a mechanism for causing the power supply of the communication module 11 to transition from the off state to the on state after the SIM card 120 is detected also in a state in which the OS is started (S0), it is possible to use the present function of the terminal device 10 according to the present embodiment in the state (S0) in which the OS is started.

Next, the determination unit 62 determines whether or not the recognized SIM information of the SIM card 120 is the same as the SIM information registered in the EEPROM 141 (step S11). For example, as shown in FIG. 3, when the SIM information stored in the EEPROM 141 of the EC 14 is only SIM phone number (1) 143, the determination unit 62 determines whether or not the recognized SIM phone number and SIM phone number (1) 143 are the same by comparing them.

However, when the SIM information stored in the EEPROM 141 includes a plurality of SIM phone numbers (1) 143 and (2) to (n) (n≥2, that is, n is equal to or larger than 2) 144, the determination unit 62 determines, for example, whether or not the recognized SIM phone number is the same as any one of SIM phone numbers (1) to (n).

When the determination unit 62 determines that the recognized SIM phone number is the same as anyone of a plurality of registered SIM phone numbers, the present process ends. On the other hand, when the determination unit 62 determines that the recognized SIM phone number is not the same as any one of the plurality of registered SIM phone numbers or when the lock control unit 65 determines that no SIM phone number is recognized, the lock control unit 65 locks the terminal device 10. Also, the communication unit 64 transmits SIM information and terminal information that are newly recognized to the management server 20 (step S12).

Also, the SMS is used for the transmission of step S12 and the SIM information and the terminal information are transmitted to the management server 20 via the SMS server 30. Here, when the carrier corresponding to the SIM card changes, the firmware of the communication module 11 needs to be rewritten. This is because a supported band differs according to each carrier and it is necessary to have firmware adapted to each carrier.

At this time, the profile setting of the SIM card has not been performed. Thus, a connection to the management server 20 using LTE cannot be made. Consequently, here, the connection is made with connectable 3G even when the profile setting has not been performed and a command is transmitted in the SMS.

For example, in domestic carriers using a 3G band I in common at present, it is unnecessary to switch the firmware even if the carrier corresponding to the SIM card changes and it is possible to transmit an SMS using the band I. Also in a carrier that does not support 3G, it is possible to technically use a system according to the present embodiment in all domestic carriers by switching the firmware or by enabling common use of the 3G band I in the future.

Returning to FIG. 6, in step S12, the communication unit 64 may transmit a SIM phone number that is the SIM information and a PIN number to the management server 20. The management server 20 receives the SIM information and the terminal information (step S110). When the terminal device 10 transmits the SIM phone number that is the SIM information, the management server 20 receives the terminal information and the SIM phone number. When the terminal device 10 has transmitted the SIM phone number that is the SIM information and the PIN number, the management server 20 receives the terminal information, the SIM phone number, and the PIN number.

The management server 20 determines whether the received terminal information is registered in the management information DB 21 (step S111). Specifically, the terminal information is information specific to the terminal device, such as a device type name, a device serial number, and an HDD serial number. The management server 20 does nothing when it is determined that the received terminal information is not registered in the management information DB 21. On the other hand, when it is determined that the received terminal information is registered in the management information DB 21, the management server 20 transmits a password input permission notification command in the SMS (step S112).

The communication unit 64 receives the password input permission notification command transmitted from the management server 20 in the SMS (step S13). Next, the reception unit 61 displays a password input screen on the display 17 (step S14) and receives an unlock password input by the user (step S15).

Also, a password for unlocking the terminal device (an unlock password) is registered in the EEPROM 141 at the time of initial activation performed by the terminal device 10 in order to receive the remote data erasure service.

Next, the lock control unit 65 determines whether or not the received unlock password is the same as the terminal unlock password registered in the EEPROM 141 (step S16). When the lock control unit 65 determines that the received unlock password is the same as the terminal unlock password 145 registered in the EEPROM 141, the lock control unit 65 unlocks the terminal device 10 and starts the OS (step S17). When the determination unit 62 determines that the received unlock password is not the same as the terminal unlock password 145 registered in the EEPROM 141, the process returns to step S14, and the processing of steps S14 to S16 is iterated until a correct unlock password is input.

When the correct unlock password is input, the terminal device 10 is unlocked in step S17, the OS is started, and the registration unit 63 causes the profile setting of the SIM card and the setting of the PIN number to be completed so that the wireless WAN 60 is used in accordance with a request from the SMS server 30 (step S18). Next, the registration unit 63 updates the SIM information (the SIM phone number) of the EC 14 (step S19). Thereby, the newly recognized SIM phone number is stored in the EEPROM 141. At this time, it is unnecessary to erase other SIM information (SIM phone number) that has already been registered and, for example, the newly recognized SIM phone number is registered as any one of SIM phone numbers (2) to (n) 144.

When the update of the SIM phone number for the EEPROM 141 has been completed, the communication unit 64 transmits a completion notification command to the management server 20 in the SMS (step S20) and the present process ends. The SIM phone number and the terminal information are transmitted to the management server 20 along with the completion notification command. The management server 20 registers the received SIM phone number in the management information DB 21 in association with the terminal information (step S113).

It is necessary to prevent a command for erasing data of the terminal device 10 from the server device from being accepted according to a request from a user of the authorized terminal device 10 when a person illegally obtaining the terminal device 10 replaces the SIM card of the terminal device 10. Thus, when the SIM information registered in advance in the terminal device 10 is different from the SIM information of the SIM card attached to the terminal device 10, there is a mechanism for preventing the terminal device 10 from being started. However, only one SIM phone number has been able to be registered in the management server 20 in the mechanism up to now. Thus, if it is determined that the SIM information recognized by the terminal device 10 is different from the SIM information registered in advance after activation, the SIM card mounted on the terminal device 10 is recognized to be different from the SIM card of the SIM information registered in the terminal device 100 in advance. As a result, the terminal device 10 is locked so that the terminal device 10 cannot be started.

In the terminal device 10 according to the first embodiment, a plurality of SIM phone numbers can be registered in the EEPROM 141 and the management server 20. Thus, it is possible to perform switching from the SIM phone number before replacement among the plurality of registered SIM phone numbers to the SIM phone number after replacement.

In the registration process according to the first embodiment, the terminal device 10 is locked until it is possible to confirm whether a person starting the terminal device 10 whose SIM card has been replaced is an authorized user. In this state, it is authenticated whether or not the user is the authorized user. When an authentication result indicates that it is determined that the user is the authorized user, the SIM information of the terminal device 10 provided in the management server 20 is updated.

Thereby, according to the registration process according to the first embodiment, when the user of the terminal device 10 receiving the provision of the remote data erasure service desires to use SIM information different from the SIM information registered in the initial activation, it is only necessary to perform the initial deactivation once and it is unnecessary to perform further activation thereafter. Thus, it is possible to reduce time and effort when the SIM card of the terminal device 10 for receiving the provision of the remote data erasure service is replaced.

Operation of Second Embodiment when Unregistered SIM is Inserted at Time of Service Validation

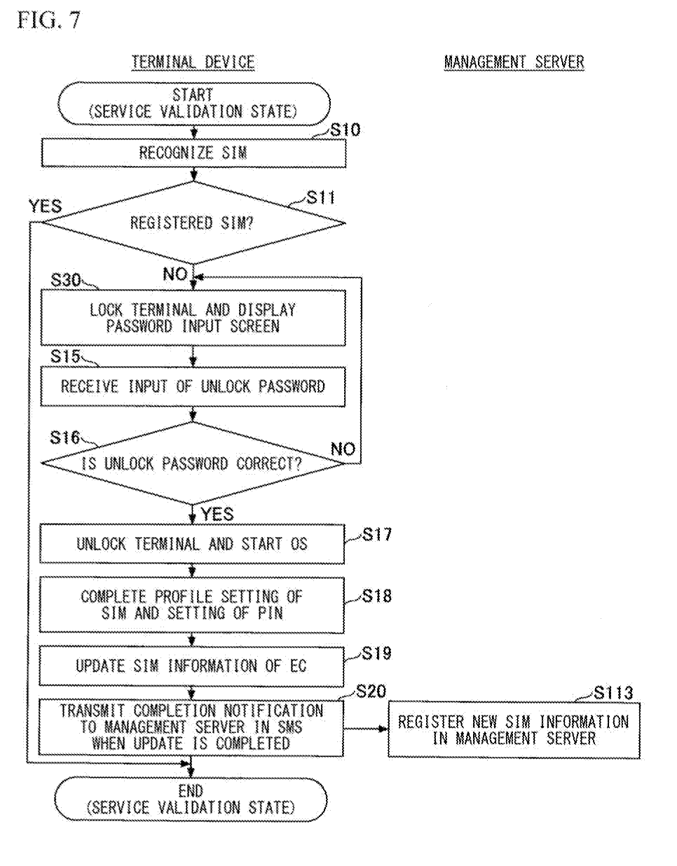

Next, the operation of the terminal device 10 according to the second embodiment will be described with reference to FIG. 7. In the second embodiment, when a SIM card unregistered at the time of service validation has been inserted into the terminal device 10, the following registration process is executed by the EC 14 without involving the management server 20. As a premise, at the start of execution of the present process, the service contract flag 146 is set to anon state and the remote data erasure service is in a valid state. Also, the step of performing the same process as the registration process according to the first embodiment of FIG. 6 is denoted by the same step reference sign and description thereof will be simplified.

First, the reception unit 61 recognizes the SIM card 120 inserted into the SIM slot 110 (step S10). Next, the determination unit 62 determines whether or not recognized SIM information of the SIM card 120 is the same as SIM information registered in the EEPROM 141 (step S11). When the determination unit 62 determines that a SIM phone number is the same as any one of a plurality of registered SIM phone numbers, the present process ends. On the other hand, when the determination unit 62 determines that the SIM phone number is not the same as any one of the plurality of registered SIM phone numbers or when it is determined that no SIM phone number is recognized, the lock control unit 65 locks the terminal device 10. Then, the reception unit 61 displays a password input screen on the display 17 (step S30) and receives an unlock password input by the user (step S15).

Next, the lock control unit 65 determines whether or not the received unlock password is the same as the terminal unlock password registered in the EEPROM 141 (step S16). When the lock control unit 65 determines that the received unlock password is the same as the terminal unlock password registered in the EEPROM 141, the lock control unit 65 unlocks the terminal device 10 and starts the OS (step S17). When the determination unit 62 determines that the received unlock password is not the same as the terminal unlock password registered in the EEPROM 141, the process returns to step S14 and the processing of steps S14 to S16 is iterated until the correct password is input.

When the OS is started in step S17, the registration unit 63 causes the profile setting of the SIM card and the setting of the PIN number to be completed so that the wireless WAN 60 is used in accordance with a request from the SMS server 30 (step S18). Next, the registration unit 63 updates the SIM information (the SIM phone number) of the EC 14 (step S19). Thereby, the newly recognized SIM phone number is stored in the EEPROM 141. At this time, it is unnecessary to erase other SIM information (another SIM phone number) that has already been registered and, for example, the newly recognized SIM phone number is registered as any one of SIM phone numbers (2) to (n) 144.

When the update of the SIM information for the EEPROM 141 has been completed, the communication unit 64 transmits a completion notification command to the management server 20 in the SMS (step S20) and the present process ends. SIM information including a SIM phone number may be transmitted along with the completion notification command. In this case, the management server 20 registers the received SIM phone number in the management information DB 21 in association with the terminal information of the terminal device 10 (step S113).

As described above, also in the registration process according to the second embodiment, when the user of the terminal device 10 for receiving the provision of the remote data erasure service desires to use SIM information different from the SIM information registered in the first activation, it is only necessary to perform initial activation once. That is, it is unnecessary to further perform activation thereafter. Thus, it is possible to reduce time and effort when the SIM card of the terminal device 10 for receiving the provision of the remote data erasure service is replaced.

Also, since there is necessity of many preparations such as necessity of an environment for connecting the terminal device 10 and the management server 20 via a wired LAN and necessity of administrator authority in order to perform activation, much time is actually spent to perform activation. Also, few people among system engineers (SEs) and customer engineers (CEs) on site for performing the activation work are accustomed to the activation work and much time is spent on the work. In this case, SEs and the CEs alone cannot cope with the problem, development staff are also required to perform the work, and more time and labor are spent on the work.

From the above, in each of the above-described embodiments, the fact that it is unnecessary to perform activation again if an unregistered SIM card is inserted when the remote data erasure service is valid is significantly useful from viewpoints for supporting SEs and CEs as well as end users.

Although the terminal device, the registration-processing program, and the registration-processing method have been described above according to the above embodiments, the terminal device, the registration-processing program, and the registration-processing method according to the present invention are not limited to the above embodiments. Various modifications and improvements are possible within the scope of the present invention. Also, when there are a plurality of embodiments and modified examples, they can be combined in a consistent range.

For example, the configuration of the system according to the above-described embodiment is an example and it is needless to say that there are various system configuration examples in accordance with the use and purpose without limiting the scope of the invention.

For example, the information stored in the management information DB 21 provided in the management server 20 according to each of the above-described embodiments may be stored in a storage device or the like on a cloud connected to the management server 20 via a network.

All of the functions or part of the functions of each unit included in the terminal device and management server according to the embodiments described above may be realized by recording a program for realizing the functions on a computer-readable recording medium and causing a computer system to read and execute the program recorded on the recording medium. The computer system refers to a system including an operating system (OS) and hardware such as peripheral devices.

The computer-readable recording medium refers to a removable medium such as a flexible disk, a magneto-optical disk, a read-only memory (ROM), and a compact disk read-only memory (CD-ROM), and a storage unit such as a hard disk disposed inside the computer system. Furthermore, in a case that the program is transferred through a network such as the internet and a communication line such as the telephone line, the computer-readable recording medium may refer to the communication line that is configured to maintain the program temporarily and dynamically, and in this case, the computer-readable recording medium may also refer to the device configured to maintain the program for a certain period such as a volatile memory inside the computer system used as a server or a client. The program may be a program for realizing part of the functions described above and the program may be combined with the program. recorded in the computer system to realize the functions.

The embodiments of the invention have been described above with reference to the drawings, but specific structures of the invention are not limited to the embodiments and may include various modifications without departing from the scope of the invention. The invention is not limited to the above-mentioned embodiments and is limited only by the accompanying claims.

What is claimed is:

1. A terminal device configured to receive a remote data erasure service from a management device, comprising:
a storage unit configured to store SIM information and unlock password information relating to a communication with the manager device;
a lock control unit configured to lock the terminal device when the SIM information recognized by the terminal device is determined to be different from the stored SIM information by referring to the storage unit;
a reception unit configured to receive an input of password information after the terminal device is locked; and
a registration unit configured to register the recognized SIM information in the storage unit when the received password information is determined to be the same as the stored unlock password information.

2. The terminal device according to claim 1, wherein the lock control unit is configured to unlock the terminal device when the received password information is determined to be the same as the stored unlock password information.

3. The terminal device according to claim 1, wherein the reception unit is configured to receive the input of the password information when the recognized SIM information is determined to be different from any one of a plurality of pieces of SIM information stored in the storage unit.

4. The terminal device according to claim 1, wherein the reception unit is configured to receive the input of the password information when the management device determines that the SIM information recognized by the terminal device is different from the stored SIM information by referring to the storage unit.

5. A registration-processing method executed by a computer to register SIM information in a terminal device configured to receive a remote data erasure service from a management device, the registration-processing method comprising:
a process of locking the terminal device when SIM information recognized by the terminal device is determined to be different from the stored SIM information by referring to a storage unit storing the SIM information and unlocking password information relating to communication with the management device;
a process of receiving an input of password information after the terminal device is locked; and
a process of registering the recognized SIM information in the storage unit when the received password information is determined to be the same as the stored unlock password information.

6. The registration-processing method according to claim 5, wherein the terminal device is unlocked when the received password information is determined to be the same as the stored unlock password information.

7. The registration-processing method according to claim 5, wherein the input of the password information is received when the recognized SIM information is determined to be different from any one of a plurality of pieces of SIM information stored in the storage unit.

8. The registration-processing method according to claim 5, wherein the input of the password information is received when the management device determines that the SIM information recognized by the terminal device is different from the stored SIM information by referring to the storage unit.

9. A non-transitory computer-readable recording medium storing a registration-processing program for causing a computer to execute a process of registering SIM information in a terminal device configured to receive a remote data erasure service from a management device, the process of registering SIM information comprising:
a process of locking the terminal device when SIM information recognized by the terminal device is determined to be different from the stored SIM information by referring to a storage unit storing the SIM information and unlocking password information relating to communication with the management device;
a process of receiving an input of password information after the terminal device is locked; and
a process of registering the recognized SIM information in the storage unit when the received password information is determined to be the same as the stored unlock password information.

10. The non-transitory computer-readable recording medium storing a registration-processing program according to claim 9, wherein the terminal device is unlocked when the received password information is determined to be the same as the stored unlock password information.

11. The non-transitory computer-readable recording medium storing a registration-processing program according to claim 9, wherein the input of the password information is received when the recognized SIM information is determined to be different from any one of a plurality of pieces of SIM information stored in the storage unit.

12. The non-transitory computer-readable recording medium storing a registration-processing program according to claim 9, wherein the input of the password information is received when the management device determines that the SIM information recognized by the terminal device is different from the stored SIM information by referring to the storage unit.
